(19) United States
(12) Patent Application Publication
(10) Pub. No.: US 2006/0120794 A1
(43) Pub. Date: Jun. 8, 2006

(54) Fluid dispensing system using an interface device attached to the top of a container for viscous fluids, paints, and the like

(76) Inventors: Mark W. Scott, Bethany, CT (US); Christopher P. Van Buiten, Oxford, CT (US)

Correspondence Address: MARK. W. SCOTT, 49 TUTTLE COURT, BETHANY, CT, 06524, US

(21) Appl. No.: 11/005,698

(22) Filed: Dec. 4, 2004

(51) Int. Cl. B43K 5/02; A46B 11/02

(52) U.S. Cl. 401/188 R

(57) ABSTRACT

An improved interface between a paint or other viscous fluid container and its paint dispensing device that enables the store-bought architectural containers to be used as part of a mobile fluid dispensing system, thereby eliminating the need for paint transfer and saving the cost of special fluid dispensing containers generally required in mobile fluid dispensing systems.

The present invention relates to the combination of improved architectural coatings containers with an interface device such that the combination replaces special fluid containers required for current mobile and stationary paint delivery systems.

### BACKGROUND

Although the system described herein can be used for a variety of viscous fluids, architectural coatings, and in particular paint is expected to be the primary working fluid. For sake of brevity, paint will be cited in the remainder of the disclosure as the working fluid. The term host container is used to describe the paint container bought by a consumer at a store. A host container is an industry standard not designed for any purpose other than to convey paint from the manufacturer to the consumer.

Applicants' previous viscous fluid container described in U.S. Pat. No. 6,530,500 B2, and U.S. Pat. No. 6,634,525 hereafter referred to as the “improved container”, was conceived based on the need to enable substantially dripless painting. The number one consumer painting complaint is the mess associated with the standard metal host container design. The improved container nearly eliminates the mess associated with pouring and painting from the container.

There are a number of dispensing devices used with conventional metal paint cans, including but not limited to paint sprayers, power rollers, and power brushes. They all must interface to metal paint cans. Attachment methods used by existing paint delivery systems to metal paint cans are prone to leakage due to an unsecured fit. Metal cans with current lids must remain upright. Current paint dispensing systems designed for home contractors and “do-it-your selfers” have a stationary unit (i.e. Wagner model “Power Roller Pro”) into which unsecured paint containers are placed. Often stationary units are overturned by pulling on the dispensing hose. Paint leaks out of the can, or worse, the lid pops off and paint pours out.

Current mobile painting systems such as the Wagner model 355e and Wagner Power Roller model 929 have special paint containers that interface with a frame and pump unit in a secure leak proof fashion. Such units require paint to be transferred from the host container to a special container. Transfer inevitably results in dripped or spilled paint and requires cleaning of the mobile painting device container. Furthermore the mobile painting system incurs the cost of the special paint container.

The commercial success of the improved containers, used as host containers, demonstrates the value consumers place on a substantially dripless painting process. The invention herein extends substantially dripless painting process to the use of paint delivery devices. The device described herein takes advantage of a threaded collar on the improved container and creates a cleaner painting process, a less costly paint delivery system, and a new method for dispensing paint. The invention is the combination of an interface device threaded on to the improved container, which makes a leak proof seal. This allows the improved container to be tipped over with no leakage. The device includes a means to allow fluid to pass from the interior to the exterior of the container. The device is designed to interface with power pumps that send paint to rollers, sprayers, brushes and the like. This combination therefore enables the improved host container to be the special paint container for mobile paint delivery devices. Hence the requirement to transfer paint from the host container to a special container is eliminated. This saves time and the messes associated with paint transfer as well as clean up of the mobile painting device paint container. Use of the improved container as the paint delivery device container eliminates the cost to manufacture the special container. Therefore the cost of the mobile fluid dispensing system can be reduced. A new method of dispensing paint has been created where the built in handle of the improved container enables the combination of the container, attached device, and pump to be carried in one hand. This is a new paint delivery device design. Such a system with no frame, no straps, and no special container has a minimum number of parts and expected to be the lowest cost fluid dispensing system possible. In short, never before has a user been able to buy paint from a store and use the host container as part of a leak proof mobile dispensing system. The invention can be also used on stationary paint delivery devices with the primary benefit being a secure lid that eliminates spillage should the unit be overturned.

In the prior art, patent application 20020195471 claims an auxiliary device attached to the threaded neck of such a new container using vacuum to send paint to a sprayer. This application however, fails to recognize the ability to use this combination as the core of a new paint delivery system with the advantages cited above and in the manner hereinafter described more fully.

### OBJECTS OF INVENTION

The primary object of the invention is to improve the painting process and reduce the cost of mobile painting delivery systems through providing a new and improved container with interface device that can be rotated to any attitude and thus enables a spill proof stationary or mobile paint dispensing device, eliminating the need for a special paint container, its cost, and the mess associated with transferring paint to and from it.

Other and further objects will be explained hereinafter and are more particularly delineated in the appended claims.

### SUMMARY

The central feature of the invention is an interface device that mates with the threads of the improved container. Such a combination enables an improved process of paint delivery and a new method of paint delivery. The following benefits are identified. The primary disadvantage of current stationary paint delivery systems is the lack of lid security to the metal paint can. Stationary systems typically have a pickup hose through a pliable lid that slips onto the top of a metal can. This lid will leak if the can is rotated sideways. Can rotation often occurs when the delivery hose is stretched too far and it pulls over the stationary unit. The invention makes a leak proof seal with the improved container and hence eliminates the possibility of leakage.

The leak proof seal enabled by the interface device on the improved container allows the container to be rotated to any attitude. This is ideal for a mobile paint delivery system where user movements can cause large container rotations and accelerations. A backpack type of mobile delivery device can be manufactured where the improved container is the paint holder. Furthermore, the integral handle on the improved container allows a user to carry the container in one hand and dispense paint with the other. A pump is used to send the paint to a hand dispensing device.

In further summary, the invention embraces use with a container for storing, dispensing, and handling viscous and semi-viscous fluids such as paint and having a threaded collar top opening through which the fluid may be dispensed, an interface device between the container and a fluid-dispensing applicator attachment having a lid for threaded and leak proof attaching to the opening threaded collar, a flexible hose line extending from the interior of the container through the lid and to the applicator attachment, a pump in the line external to the lid for conducting the fluid from the interior to the exterior of said container and to the attachment, wherein a mobile fluid dispensing system is provided with the container serving as the fluid source.

Preferred and best mode design will later be more fully addressed.

### DRAWINGS

The invention will now be described in connection with the accompanying drawings, in which:

FIG. 1 is a diagram of an improved fluid dispensing system including an exploded view of the improved container, the interface device, a pump, and several dispensing devices.

FIG. 2 is a diagram of an improved mobile fluid dispensing system utilizing a backpack frame and the elements from FIG. 1.

FIG. 3 is an alternate embodiment of the device shown in FIG. 2 where the pump is attached to the frame.

FIG. 4 is a similar view showing the painter using the system as a portable module paint dispensing system with a pump in the lid.

### DESCRIPTION OF PREFERRED EMBODIMENT(S) OF INVENTION

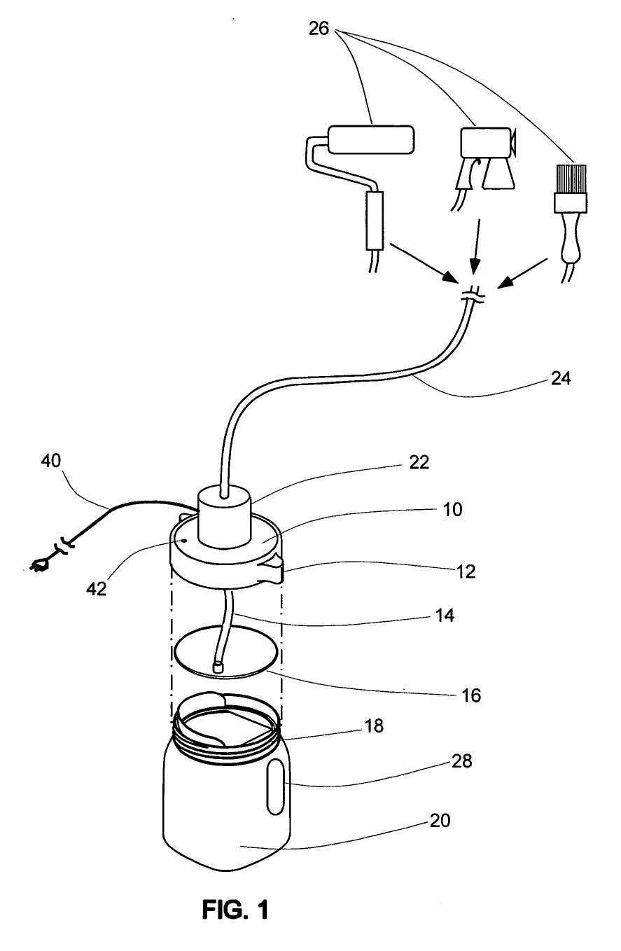

The preferred embodiment in FIG. 1 is an exploded isometric view of the interface device 10 in context with the components of an improved paint delivery system. The interface device 10 is preferably of single piece plastic construction. The interface device 10 may be blow molded or injection molded of high density polyethylene (HDPE) or similar plastic. The interface device is designed to mate with the threads of the before-described improved container 20, such as in applicants' previously cited U.S. Pat. No. 6,530,500 B2, and U.S. Pat. No. 6,634,525. Other methods of secure lid attachment will be evident to those skilled in the art. The interface device can be designed by those skilled in the art to mate with whatever attachment method is used on a host improved container. The interface device 10 incorporates a vent 42 to allow air to replace the volume of fluid removed. In the embodiment shown in FIG. 1 the improved container 20, as described in the above patents, has a threaded neck 18 on to which the interface device 10 is screwed on. In this embodiment, a gasket ring 16 is used to improve the seal between improved container 20 and interface device 10.

An alternate embodiment would not use the gasket seal and may rely on the surface contact between the improved container 20 and the interface device 10. The embodiment shown in FIG. 1 however, shows a fluid pump 22 attached to the interface device 10. A flexible hose 24 is attached to pump 22 and terminates with one of a variety of hand held paint delivery and fluid control devices 26.

With three examples of hand held devices are shown, other dispensing devices are possible. An electrical chord 40 emanates from the pump 22 to a standard electrical plug. An alternate embodiment has a battery operated pump. This embodiment would be similar in design except the chord 40 would not be present.

Thumb ears 12 are shown as a means to tighten and loosen the interface device 10. Other means of tightening and loosening are possible and evident to those skilled in the art. There is a flexible pickup tube 14, sometimes referred to as a flop tube, which extends from the pump 22 through the interface device 10 and to the bottom of the improved container 20. The pickup tube 14 allows paint to be picked up at large container attitudes.

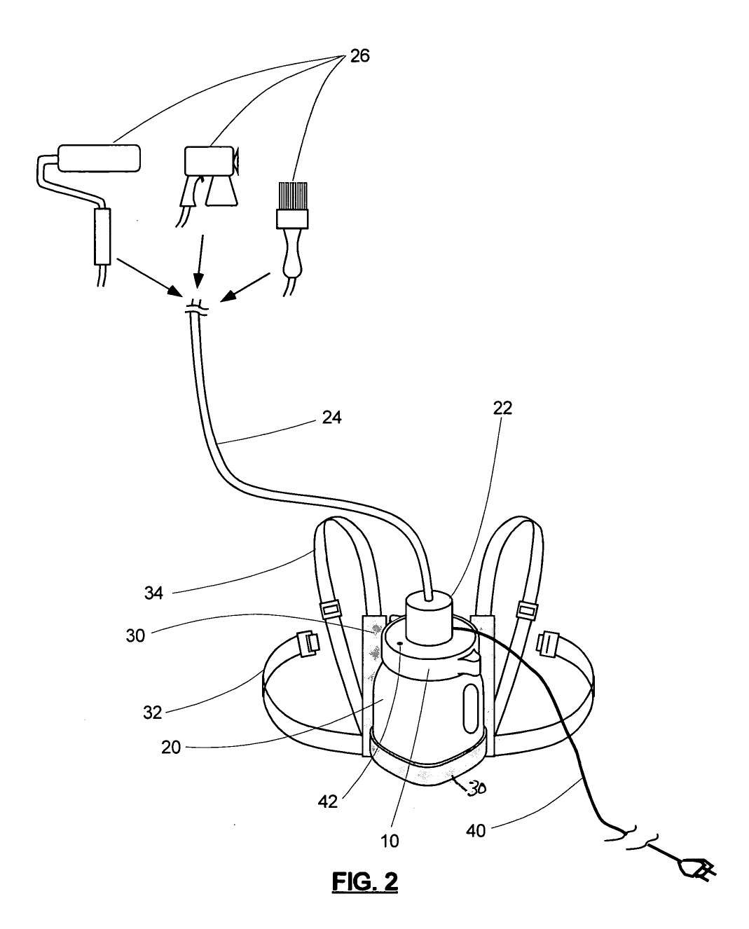

FIG. 2, as before described, is a diagram of the interface device 10 attached improved container 20, both supported by a backpack type of frame 30 shown as shaded. Shoulder straps 34 and belt 32 enable a painter 38 to carry fame 30 on his or her back. Other means of frame support by painter 38 such as a single strap or handle are possible. The embodiment in FIG. 2 shows the pump 22 attached to the interface device 10. In another embodiment of FIG. 2, the electrical cord 18 may be replaced by battery(s) integral to the mobile paint delivery system.

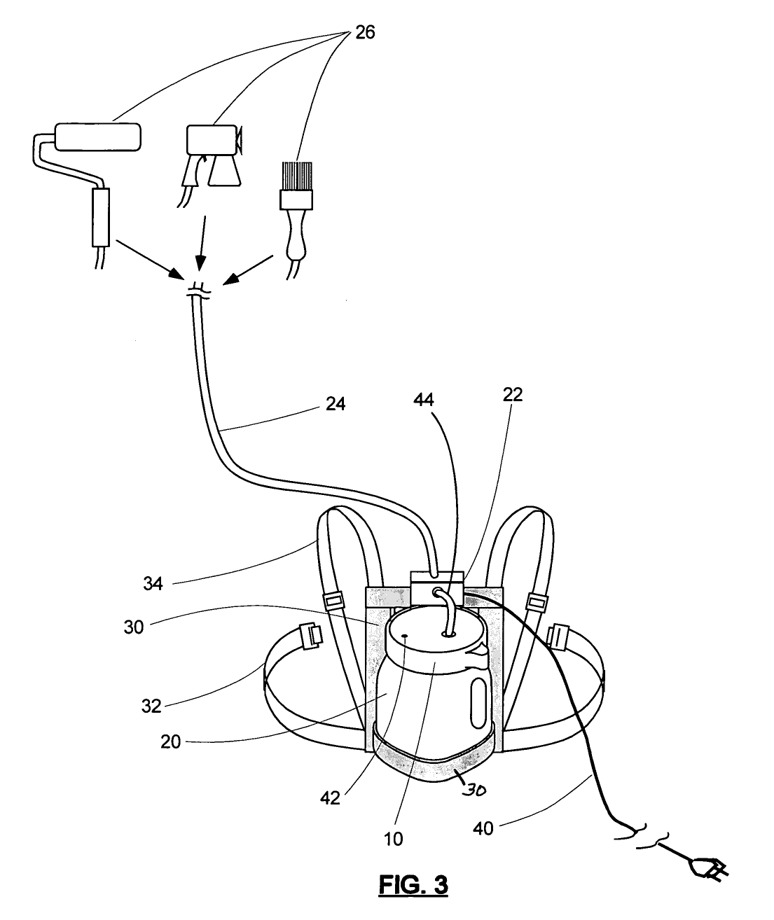

FIG. 3 is an alternate embodiment where the pump 22 is attached to frame 30. A detachable pick up hose 44 at pump 22 runs through the interface device 10 to the bottom of container 20.

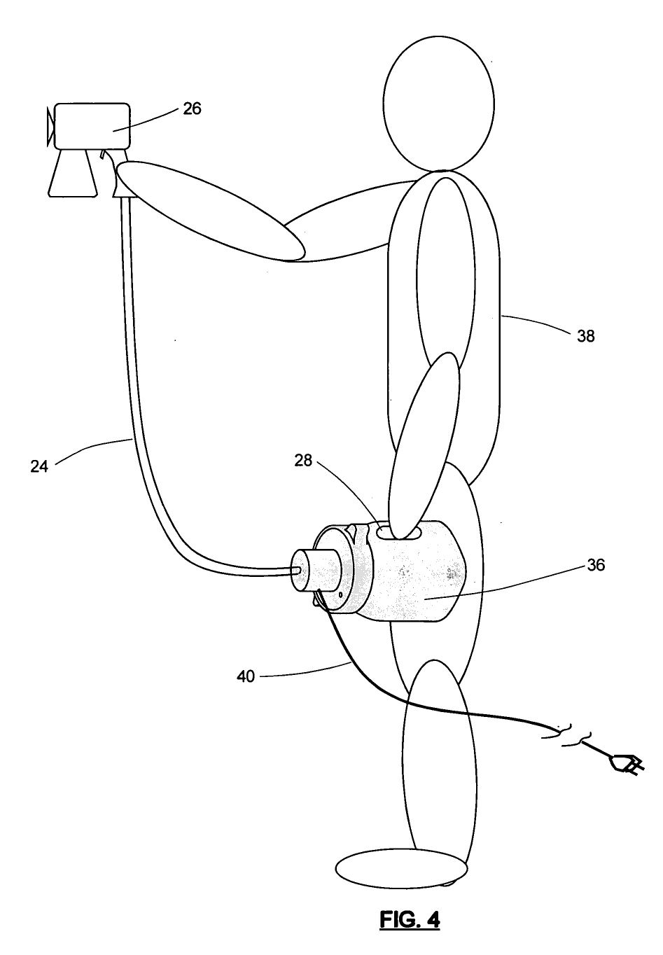

FIG. 4 illustrates a new mobile paint dispensing method enabled by the interface device 10 of the invention. Objects 20, 16, 14, 10, and 22 in combination constitute the major elements of an integral paint delivery device 36 shown shaded in FIG. 3. The large integral handle 28 is very comfortable and offers a secure balanced handhold to the improved container 20. The painter 38 is able to move about freely without dragging the paint hose. If painter 38 desires, the integral paint delivery device 36 can be placed on the ground at any attitude with out paint leakage. This mobile system can therefore be rapidly changed to stationary system and back. As can be seen this new paint delivery system has a minimum number of parts. Manufacturing, inventory, and shipping costs of this system will be lower than existing mobile paint delivery systems.

Further modifications will also occur to those skilled in the art, and such are considered to fall within the spirit and scope of the invention as defined in the appended claims.

1. For use with a container for storing, dispensing, and handling viscous and semi-viscous fluids such as paint and having a threaded collar top opening through which the fluid may be dispensed, an interface device between the container and a fluid-dispensing applicator attachment having a lid for threaded and leak proof attaching to the opening threaded collar, a tube extending from the interior of the container through the lid and to a pump mounted external to the lid for conducting the fluid from the interior to the exterior of said container and a flexible hose line externally connected from the pump to the attachment, wherein a mobile fluid dispensing system is provided with the container serving as the fluid source.

2. The system in claim 1, further including a carrying frame having a rearward bottom frame portion for receiving and supporting said container with its said interface device.

3. The system of claim 1 wherein the pump is attached external to the lid.

4. The system of claim 3 wherein the dispensing attachment is a spray gun.

5. The system of claim 3 wherein the dispensing attachment is a roller.

6. The system of claim 3 wherein the dispensing attachment is a brush.

7. The system of claim 3 wherein the dispensing attachment is a pad.

8. The system of claim 1 wherein the container is inverted and gravity feeds to the fluid dispensing attachment.

9. The system of claim 1 wherein the lid provides a fluid mixing device for mixing fluid in said container.

10. For use with a container for storing, dispensing, and handling viscous and semi-viscous fluids such as paint and having a threaded collar top opening through which the fluid may be dispensed, an interface device between the container and a fluid-dispensing applicator attachment having a lid for threaded and leak proof attaching to the opening threaded collar, a tube extending from the interior of the container through the lid and to a pump mounted external to the lid for conducting the fluid from the interior to the exterior of said container, and a flexible hose line externally connected from the pump to the attachment, wherein a mobile fluid dispensing system is provided with the container serving as the fluid source, and wherein a container integral side-handle is provided extending along and spaced from a side of the container for enabling handheld carrying or positioning during dispensing.

11. The system of claim 2 wherein the pump is attached to the carrying frame.
